(19) United States
(12) Patent Application Publication
(10) Pub. No.: US 2026/0346538 A1
(43) Pub. Date: Nov. 5, 2026

(54) THERMALLY STABLE WATER SOLUBLE POLYMER COMPOSITIONS

(71) Applicant: Interfacial Consultants LLC, Prescott, WI (US)

(72) Inventors: Nathan W. Ockwig, Eagan, MN (US); Steven D. Koecher, River Falls, WI (US)

(21) Appl. No.: 19/119,847

(22) PCT Filed: Oct. 13, 2023
(86) PCT No.: PCT/US2023/035107

§ 371 Date: Apr. 10, 2025

Related U.S. Application Data
(60) Provisional application No. 63/415,676, filed on Oct. 13, 2022.

(51) Int. Cl. B29C 64/118; B29K 67/00; B29K 307/04; C08K 3/04; C08K 5/526; C08K 5/5393

(52) U.S. Cl. CPC B29C 64/118; C08K 3/041; C08K 5/526; C08K 5/5393; B29K 2067/00; B29K 2307/04

(57) ABSTRACT

A thermally stable water soluble polymer composition includes at least one water soluble polymer and at least one reinforcing filler. Thermally stable water soluble polymer compositions, including at least one water soluble polymer and at least one reinforcing filler can solve several additive manufacturing problems: such compositions can dissolve or disintegrate in water, at neutral pH, can be compatible with both hydrophilic and hydrophobic polymers, and can be used as a support material for build chamber temperatures of at least about 180 °C, have a modulus at print chamber temperatures above 1×10⁶ Pa, and are easily removable (soluble/disintegrate) after printing at this build chamber temperature for at least 24 hours all which may, for example, be desirable when 3D printing high temperature engineering thermoplastics.

### CROSS-REFERENCE TO RELATED APPLICATION

This application claims priority to U.S. Provisional Application No. 63/415,676 filed Oct. 13, 2022, which is hereby incorporated by reference.

### TECHNICAL FIELD

This disclosure relates to compositions and methods for making and using a thermally stable water soluble polymer composition.

### BACKGROUND

Additive manufacturing processes, commonly referred to as three-dimensional (3D) printing, can be used to construct desired objects with possible applications in numerous industries (e.g., aerospace, automotive, medical, etc.). Exemplary processes include, but are not limited to, binder jet, electron beam melting (EBM), fused deposition modeling (FDM), fused filament fabrication (FFF), direct extrusion, ink jetting, laminated object manufacturing (LOM), selective laser sintering (SLS), selective toner electrophotographic process (STEP) and stereolithography (SL). Using such processes, a desired object can be modeled in a computer-aided design (CAD) package and printed using a selected build material. For deposition-based methods, like FDM, the selected build material is typically extruded through a heated printer in a layered manner according to computer instruction. Printing in commercially available additive manufacturing devices, like, for example, the ARBURG™ Freeformer system, often occurs in a build chamber that can provide heating and temperature control.

Many additive manufacturing techniques use support layers or structures to build a desired object. The limited availability of suitable support methods, materials, and structures, however, has restricted 3D printing to certain design types. The most basic support method uses the same material for support as it does for the printed object. With this technique, a support is erected similarly to scaffolding on a building and “props up” any steeply angled overhangs or spans. Referred to as “breakable” or “raft” support, this type of support can be effective, but can also be messy, time-consuming, and difficult to remove by mechanical breakage or trimming. It is not unusual to spend hours cleaning or cutting away support material from a 3D-printed object using razor blades, scalpels, sandpaper, and even power tools. Methods using different support and printed materials can also be problematic. For example, certain hydrophobic polymers (e.g., polypropylene) are nearly impossible to print due to the incompatibility between the support materials and the 3D-printed base resin.

The inability to remove internal support materials can further restrict object design types. Some external geometries can make it difficult, if not impossible, to remove internal support material. For years, many have tried to solve this problem with support structures that are supposed to dissolve in very hot water, highly acidic or basic conditions, organic solvents, or various other chemicals. These products are often messy and even dangerous—and in general have been unsuccessful. Another challenge is associated with creating support materials that are not only water soluble but are also thermally stable for the printing conditions required for certain high temperature engineering thermoplastics like polyetheretherketone (PEEK), polyetherketoneketone (PEKK), polyphenylenesulfone (PPSU), and polyetherimide (PEI). Typically, such materials can require high melt temperatures (above 270 °C), high printing chamber temperatures (above 180 °C) for extended periods of time (>24 hours). The disclosure herein, provides compositions of matter for thermally stable water soluble polymer compositions that properly function under these extreme conditions, while maintaining sufficient dissolution/removal characteristics after printing is complete.

### SUMMARY

Thermally stable water soluble polymer compositions, including at least one water soluble polymer (e.g., sulfopolyester (SPE)) and at least one reinforcing filler (e.g., carbon nanotubes), can solve several additive manufacturing problems: such compositions can dissolve or disintegrate in room temperature water, at neutral pH, can be compatible with both hydrophilic and hydrophobic polymers, can be used as a support material for build chamber temperatures of at least about 180 °C, have a modulus at print chamber temperatures above 1×10⁶ Pa, and are easily removable (soluble/disintegrate) after printing at this build chamber temperature for at least 24 hours all which may, for example, be desirable when 3D printing high temperature engineering thermoplastics.

Additionally, thermally stable water soluble polymer compositions can be unique in that such compositions may result in improved mechanical properties, temperature resistance, and functionality. Some embodiments have improved mechanical properties that make the thermally stable water soluble polymer composition amenable for 3D printing using a filament type printer, including modulus, storage modulus (at elevated temperatures), impact strength, tensile strength, and coefficient of linear thermal expansion (CLTE). For example, when a water soluble polymer is melt processed with a reinforcing filler, it can produce a thermally stable water soluble polymer composition with increased modulus at high print chamber temperatures, a desirable attribute for fused deposition modeling (FDM) and direct extrusion 3D printers.

In some embodiments, a thermally stable water soluble polymer composition includes at least one water soluble polymer and at least one reinforcing filler. The water soluble polymer and reinforcing filler can be combined using conventional melt processing techniques such as twin screw extrusion.

In some embodiments, a three-dimensional printed article includes a three-dimensional printed object generally deposited on a substantially horizontal build plate in a build chamber and one or more soluble supports, including a thermally stable water soluble polymer composition, positioned about and supporting one or more portions of the three-dimensional printed object. The thermally stable water soluble polymer composition can be formed by melt processing a water soluble polymer and a reinforcing filler. The thermally stable water soluble polymer composition can, e.g., be substantially stable at build chamber temperatures of at least about 180 °C. In other embodiments, the build material of the three-dimensional printed article includes a thermally stable water soluble polymer composition.

In some embodiments, a thermally stable water soluble support is formed by melt processing a water soluble polymer and a reinforcing filler. The water soluble support is substantially dry and substantially stable at build chamber temperatures of at least about 180 °C.

The above summary is not intended to describe each disclosed embodiment or every implementation. The detailed description that follows more particularly exemplifies illustrative embodiments.

### BRIEF DESCRIPTION OF THE DRAWINGS

FIG. 1 is an image of a thermally stable water soluble polymer composition that has been printed using an Arburg Freeformer 300X at a chamber temperature of 140 °C.

FIG. 2 is an image of a thermally stable water soluble polymer composition that has been printed using an Arburg Freeformer 300X at a chamber temperature of 200 °C.

FIG. 3 is an image of a thermally stable water soluble polymer composition that has been printed using an Arburg Freeformer 300X with polyetherimide (PEI, ULTEM 9085) at a chamber temperature of 185 °C.

FIG. 4 is an image of a thermally stable water soluble composition that has been printed using an AON M2+ with polyetherketoneketone (PEKK) at a chamber temperature of 70 °C.

FIG. 5 is an image of a thermally stable water soluble composition that has been printed using an Arburg Freeformer 300X with polyetheretherketone (PEEK) at a chamber temperature of 200 °C.

FIG. 6 is an image of a thermally stable water soluble composition that has been printed on a AON M2+ with polyetheretherketone (PEEK) at a chamber temperature of 65 °C.

FIG. 7 shows the resulting appearances of formulations 18-22 annealing at 0 and 24 hours.

### DETAILED DESCRIPTION

Unless the context indicates otherwise the following terms shall have the following meaning and shall be applicable to the singular and plural:

The terms “a,” “an,” “the,” “at least one,” and “one or more” are used interchangeably. Thus, for example, a thermally stable water soluble polymer composition including “a” water soluble polymer means that the thermally stable water soluble polymer composition may include “one or more” water soluble polymers.

The terms “additive manufacturing”, “three-dimensional printing”, “3D printing,” or “3D printed” refer to any process used to create a three-dimensional object in which successive layers of material are formed under computer control (e.g., electron beam melting (EBM), fused deposition modeling (FDM), direct extrusion, ink jetting, laminated object manufacturing (LOM), selective laser sintering (SLS), selective toner electrophotographic process (STEP), and stereolithography (SL)).

The term “build chamber” refers to a volume, often enclosed, in or utilized by an additive manufacturing device within which a desired object can be printed. A non-limiting example of build chamber can be found in an ARBURG™ Freeformer (commercially available from Arburg GmbH, Lossburg, Germany).

The term “build chamber temperature” refers to the temperature provided in a build chamber during additive manufacturing.

The term “build material” refers to a material that is printed in three dimensions using an additive manufacturing process to produce a desired object, often remaining after removal of a soluble support.

The term “build plate” refers to a substrate, often a removable film or sheet, that a build material or soluble support can be printed on.

The term “composition” refers to a multicomponent material.

The term “copolymer” refers to a polymer derived, actually (e.g., by copolymerization) or conceptually, from more than one species of monomer. A copolymer obtained from two monomer species is sometimes called a bipolymer; a copolymer obtained from three monomers is sometimes called a terpolymer; a copolymer obtained from four monomers is sometimes called a quatrapolymer; etc. A copolymer can be characterized based on the arrangement of branches in the structure, including, e.g., as a linear copolymer and a branch copolymer. A copolymer can also be characterized based on how the monomer units are arranged, including, e.g., as an alternating copolymer, a periodic copolymer, a statistical copolymer, a graft copolymer, and a block copolymer.

The term “crystalline” refers to a polymeric composition with crystallinity greater than 90% as measured by differential scanning calorimetry (DSC) in accordance with ASTM standard D3418-12—Standard Test Method for Transition Temperatures and Enthalpies of Fusion and Crystallization of Polymers by Differential Scanning calorimetry.

The term “filler” refers to a material which is immiscible in the thermally stable water soluble polymer composition and modifies the end-use properties.

The term “feedstock” refers to the form of a material that can be utilized in an additive manufacturing process (e.g., as a build material or soluble support). Non-limiting feedstock examples include pellets, powders, filaments, billets, liquids, sheets, shaped profiles, etc.

The term “high temperature thermoplastic” refers to a polymer or polymeric composition that is typically melt processed at or above about 220 °C. Non-limiting examples of high temperature thermoplastics include, but are not limited to, polycarbonate (PC), polyamides (Nylon), polyesters (PET), polyetheretherketone (PEEK), polyetherketoneketone (PEKK), polyphenylene sulfone (PPSU), and polyetherimide (PEI).

The term “melt processing technique” refers to a technique for applying thermal and mechanical energy to reshape, blend, mix, or otherwise reform a polymer or composition, such as compounding, extrusion, injection molding, blow molding, rotomolding, or batch mixing. 3D printing processes that are useful in printing thermoplastic and elastomeric melt processable materials are examples of a melt processing technique.

The term “mixing” means to combine or put together to form one single substance, mass, phase, composite, dispersion, or more homogenous state. This may include, but is not limited to, all physical blending methods, extrusion techniques, or solution methods.

The term “monomer” refers to a molecule that can undergo polymerization to contribute structural units to the essential structure of a polymer.

The terms “polymer” and “polymeric” refer to a molecule of high relative molecular mass, the structure of which essentially contains multiple repetitions of units derived, actually or conceptually, from molecules of low relative molecular mass (monomers). The term “polymer” can refer to a “copolymer.”

The term “reinforcing filler” refers to a material that is not viscoelastic under the melt processing conditions to produce the thermally stable water soluble polymer composition and has a diameter less than 200 nm and an aspect ratio greater than 10:1.

The term “semi-crystalline” refers to a polymeric composition with crystallinity greater than 5% but less than 90% as measured by differential scanning calorimetry (DSC) in accordance with ASTM standard D3418-12—Standard Test Method for Transition Temperatures and Enthalpies of Fusion and Crystallization of Polymers by Differential Scanning Calorimetry.

The terms “soluble support”, “soluble support material”, or “water soluble support” refer to a material that is printed in three dimensions using an additive manufacturing process to physically support or brace the build material during 3D printing and that can be removed by chemical solvation or dissolution as desired during or after the additive manufacturing process.

The term “stabilizer” means, one or more additives or materials which substantially, whether in reality or conceptually, enhances the resistance of a polymer to degradative processes (mechanical, thermal, hydrolytic, acid/base, oxidative, free radical, ultraviolet or any other forms of radiation).

The term “substantially dry” means that the substance contains by weight about 15% or less volatiles, or about 10% or less volatiles, at standard conditions based on the weight of the thermally stable water soluble polymer composition.

The terms “substantially stable” or “substantial stability” refer to a material that largely exhibits dimensional stability (e.g., with minimal flow, melting, or deformation) at print processing temperatures (e.g., a build chamber temperature).

The term “thermally stable” refers to a water soluble polymer composition that has a decomposition temperature greater than 275 °C (by thermogravimetric analysis) and has a modulus greater than 1×10⁶ Pa at build chamber temperatures at or above 180 °C and below the thermal decomposition temperature of the water soluble polymer or reinforcing filler.

The term “thermally stable water soluble polymer composition” refers to a composition that includes at least one water soluble polymer and at least one reinforcing filler, and can optionally include fillers, stabilizers, or additives.

The term “water soluble” refers to a material that absorbs, swells, dissolves, disintegrates, or deteriorates in the presence of water.

The recitation of numerical ranges using endpoints includes all numbers subsumed within that range (e.g., 1 to 5 includes 1, 1.5, 3, 3.95, 4.2, 5, etc.).

The thermally stable water soluble polymer compositions of the present disclosure comprise at least one water soluble polymer and at least one reinforcing filler. In another embodiment, a thermally stable water soluble polymer composition employs a variety of additives, which can enhance solubility, adhesion to build materials, thermal stability, mechanical properties and other desirable attributes.

A variety of water soluble polymers may be employed in a thermally stable water soluble polymer composition. Non-limiting examples of water soluble polymers include coagulants, such as quaternary polyamines, sulfopolyesters, sulfopolyester salts, polydiallyl ammonium chloride (polyDADMAC), and dicyandiamide resins; flocculants and polymeric surfactants, such as nonionic, anionic, and cationic materials; amphoteric polymers; polyethyleneimines; polyamide-amines; polyamine-based polymers; polyethylene oxides; sulphonated compounds; polyvinylpyrrolidone; polylactic acid; polylactones; polyacrylate-type dispersants; poly vinyl alcohols; butendiol vinyl alcohol copolymers; cellulose derivatives; and copolymers or combinations thereof.

Non-limiting examples of water soluble polymers useful in this disclosure include sulfopolyester salts sold as AQ™ resins by Eastman. Non-limiting examples of water soluble copolymers include copolymers of polyvinyl alcohols (PVOH), including polyvinyl alcohol-co-vinylpyrrolidinone (PVOH-co-PVP), polyvinyl alcohol-co-vinylamine, polyvinyl alcohol-co-vinyl acetate, polyvinyl alcohol-co-butenediol vinyl alcohol, polyvinyl alcohol-co-vinyl acetate, polyvinyl alcohol-co-polyacrylate, and polyvinyl alcohol-co-polymethacrylate. Non-liming examples of commercially available water soluble copolymers include PVOH-co-PVP, sold as ULTILOC 4005™ by Seikisui Corporation; BVOH, sold as NICHIGO G-POLYMER™ by Nippon Goshei; poly-2-ethyloxazoline, sold as AQUAZOL™ by Polymer Chemistry Innovations, Inc.; and hydroxypropyl methylcellulose, sold as AFFINISOL™ by Dow Chemical Co.

A variety of reinforcing fillers may be employed in a thermally stable water soluble polymer composition. A reinforcing filler may impart certain physical properties including, but not limited to, increasing the viscosity or modulus of the material at elevated temperatures. Non-limiting examples of reinforcing fillers useful in this disclosure include nanomaterials that have a diameter of less than 200 nm and an aspect ratio greater than 10:1. Non-limiting examples of nanomaterials useful in this disclosure include single walled carbon nanotubes, multiwalled carbon nanotubes, functionalized carbon nanotubes, boron nitride nanotubes, ceramic nanotubes, ceramic nanorods, metal nanowires, metal oxide nanowires, metal oxide nanorods, inorganic nanowires, inorganic nanorods, polymeric nanofibers, fibrous mineral species, cellulosic fibrils, etc. In other embodiments, a reinforcing filler includes carbon nanotubes such as those commercially manufactured by Nanocyl, Inc, sold commercially as grade NC7000.

A variety of different loading levels of water soluble polymer and reinforcing fillers can be employed in a thermally stable water soluble polymer composition. In some embodiments, a thermally stable water soluble polymer composition may, for example, include at least about 80 wt % water soluble polymer, or at least about 85 wt % water soluble polymer, or at least about 90 wt % water soluble polymer, or at least about 99.5 wt % water soluble polymer. In some embodiments, a thermally stable water soluble polymer composition may, for example, include between 0.5 to 20 wt % of a reinforcing filler. In some embodiments, a thermally stable water soluble polymer composition may include at least about 0.5 wt % reinforcing filler, or at least about 1 wt % reinforcing filler, or at least about 2 wt % reinforcing filler, or at least about 5 wt % reinforcing filler, or at least about 10 wt % reinforcing filler, and up to about 20 wt % reinforcing filler. In another embodiment, the thermally stable water soluble polymer composition contains between 0.5 to 20 wt % of an reinforcing filler. In yet another embodiment, the thermally stable water soluble polymer composition contains between 1 to 10 wt % of a reinforcing filler.

The thermally stable water soluble polymer composition of this disclosure may include additives to impart additional functionality. Non-limiting examples of suitable additives include stabilizers, carbohydrates, light stabilizers, antioxidants, secondary antioxidants, fibers, blowing agents, foaming additives, antiblocking agents, heat reflective materials, heat stabilizers, impact modifiers, biocides, antimicrobial additives, compatibilizers, plasticizers, tackifiers, processing aids, lubricants, slip agents, coupling agents, thermal conductors, electrical conductors, catalysts, flame retardants, oxygen scavengers, fluorescent tags, fillers, minerals, metals, and colorants. Additives may be incorporated into a thermally stable water soluble polymer composition as a powder, liquid, pellet, granule, or in any other melt processable form. The amount and type of conventional additives in a thermally stable water soluble polymer composition may vary depending upon the polymeric matrix and the desired properties of the finished composition. In view of this disclosure, a person having ordinary skill in the art will recognize that an additive and its amount can be selected in order to achieve desired properties in the finished material. Typical additive loading levels may be, for example, approximately 0.01 to 20 wt % of the composition formulation. Suitable carbohydrate additives include, for example, those disclosed in U.S. Pat. No. 10,435,576 incorporated by reference herein in its entirety.

In one embodiment, a stabilizer is added to a thermally stable water soluble polymer composition to help further improve the thermal stability of the thermally stable water soluble polymer composition. A stabilizer typically is selected by one skilled in the art depending on the specific thermally stable water soluble polymer composition. Non-limiting examples of stabilizers useful in this disclosure include phosphites, polyaromatic phosphites, inorganic phosphates, hindered phenolics, or thioesters. In other embodiments, Hostanox P-EPQ (e.g., phosphorous tricloride reactions products with 1,1′-biphenyl and 2,4-bis(1,1-dimethylethyl) phenol) or ADK STAB PEP-36 (e.g., [2,2-bis[(2,6-ditert-butyl-4-methylphenoxy)methyl]-3-dihydroxyphosphanyloxypropyl] dihydrogen phosphite) are useful stabilizers for a thermally stable water soluble polymer composition. Typical stabilizer loading levels may be, for example, approximately 0.01 to 10 wt % of the thermally stable water soluble polymer composition.

In another embodiment, a filler is added to a thermally stable water soluble polymer composition. Fillers are useful in that they allow one skilled in the art to adjust mechanical properties of the end-use article made using a polymeric material. Fillers can function to improve mechanical and thermal properties of the polymeric material. Fillers can also be utilized to reduce the coefficient of linear thermal expansion (CLTE) of the polymeric article. Non-limiting examples of fillers are mineral and organic fillers including carbonates, silicates, talc, mica, wollastonite, clay, silica, alumina, carbon fiber, carbon black, carbon nanotubes, graphite, graphene, volcanic ash, expanded volcanic ash, perlite, glass fiber, solid glass microspheres, hollow glass microspheres, cenospheres, ceramics, and conventional cellulosic materials including: wood flour, wood fibers, sawdust, wood shavings, newsprint, paper, flax, hemp, wheat straw, rice hulls, kenaf, jute, sisal, peanut shells, soy hulls, or any cellulose containing material. The amount of filler in a thermally stable water soluble polymer composition after melt processing is typically between 1 to 60 wt %. In another embodiment, the filler loading level is between 1 to 50 wt %. In yet another embodiment, the filler loading level is between 1 to 30 wt %.

A thermally stable water soluble polymer composition can be prepared by mixing, processing, or a combination thereof. Depending on the selected water soluble polymer matrix, this can be done using a variety of mixing processes known to those skilled in the art in view of this disclosure. The water soluble polymer, reinforcing filler, and any optional additives can be combined, e.g., by a compounding mill, a Banbury mixer, or a mixing extruder. In another embodiment, a vented twin screw extruder is utilized. The materials may be used in the form of, for example, a powder, a pellet, a liquid, or a granular product. The mixing operation is most conveniently carried out at a temperature above the melt processing temperature of the water soluble polymer or the reinforcing filler, or above the melt processing temperatures of both the water soluble polymer and the reinforcing filler. The resulting melt processed thermally stable water soluble polymer composition can be extruded directly into the form of the final product shape, or can be pelletized or fed from the melt processing equipment into a secondary operation to pelletize the composition (e.g., using a pellet mill or densifier) for later use. In another embodiment, the thermally stable water soluble polymer composition and additives can be 3D printed directly.

A thermally stable water soluble polymer composition can undergo additional processing for desired end-use applications. A thermally stable water soluble polymer composition can be used as a feedstock in fused deposition modeling (FDM). In some embodiments, the feedstock may be a filament but other feedstocks (e.g., film, sheet, shaped profile, powder, pellet, etc.) can also be used. For an FDM feedstock, it is desirable to have a proper balance of stiffness and toughness. This is because the material must function properly when processed using an FDM based 3D printer. If the material is too soft, it has a tendency to flex when the drive system tries to push or pull the filament into or out of the filament extruder head or liquifier. If the filament is not tough enough, it has a tendency to break or deform when traveling through the path to the filament extruder head. Those skilled in the art will recognize that an FDM filament composition should be designed to have the proper balance of stiffness and toughness in order to function with an FDM type printer.

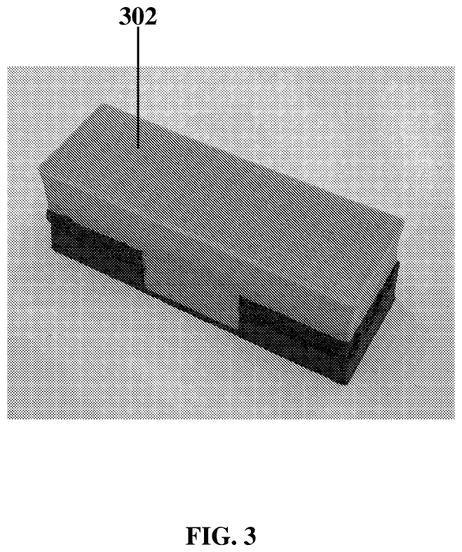

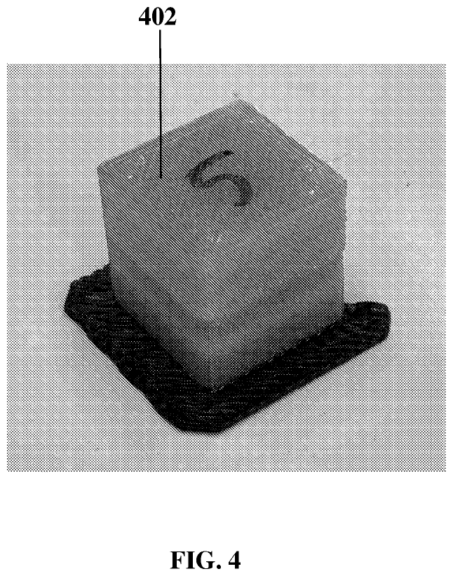

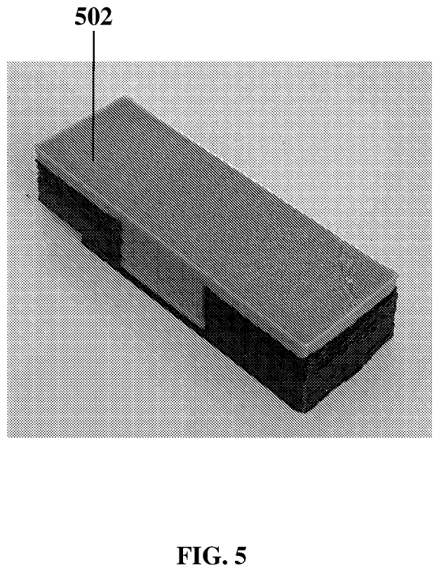

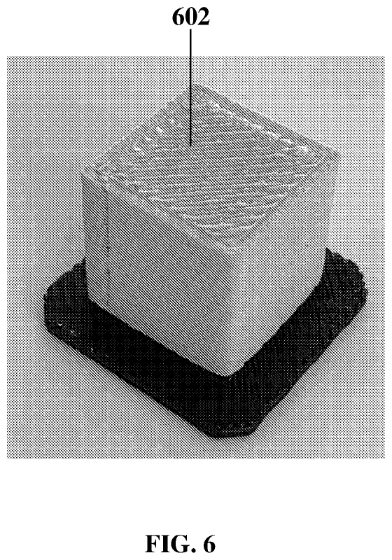

It is well known in additive manufacturing that it can be challenging to print semi-crystalline and crystalline polymers because they have a tendency to shrink in the build chamber when allowed to relax. This can result in part warpage and curling of the build material. For this reason, build chamber temperatures above the glass transition temperature of the build material are typically required to prevent part warpage. Surprisingly, thermally stable water soluble polymer compositions of this disclosure, can enable printed parts with low warpage. This may be in part due to the excellent adhesion of the thermally stable water soluble polymer compositions to a variety of build materials and to the build plate. Thermally stable water soluble polymer compositions can also show remarkable adhesion properties to a wide range of build plates and build materials including: polyamide (e.g., Nylon 6, Nylon 6.6, Nylon 12), polyimide (e.g, Kapton), polyether-imide (PEI) as shown as 302 in FIG. 3, polyetherketoneketone (PEKK) as shown as 402 in FIG. 4, polyetheretherketone (PEEK) as shown as 502 in FIG. 5 and as 602 in FIG. 6, polyacrylonitrile-butadiene-styrene (ABS), polylactic acid (PLA), polyacrylic (e.g., PMMA), polycarbonate (PC), glass, metal, and others.

A thermally stable water soluble polymer composition can be used in additive manufacturing as a build material, or as a support material to create a water soluble support. A thermally stable water soluble polymer composition can also be converted into an article using conventional melt processing techniques, such as compounding, extrusion, molding, and casting, or other additive manufacturing processes. For use in additive manufacturing processes, a variety of additive manufacturing devices can employ thermally stable water soluble polymer compositions as, for example, a water soluble support or build material. Non-limiting examples of such additive manufacturing devices include, but are not limited to, the Dremel DigiLab 3D45 3D Printer, LulzBot Mini 3D Printer, MakerBot Replicator+, XYZprinting da Vinci Mini, Ultimaker 3, Flashforge Finder 3D Printer, Robo 3D R1+Plus, Ultimaker 2+, Ultimaker S5, Titan Atlas, Arburg Freeformer 300X, Tumaker Bigfoot 350 Pro Dual, Intamsys 610, and AON M2.

A thermally stable water soluble polymer composition can be selectively removed as either a build or support material (e.g., by dissolution or mechanically) manually, automatically (e.g., computer controlled dissolution), or by some combination thereof. For example, a thermally stable water soluble polymer composition can dissolve or disintegrate when exposed to water such that they are easy to remove from the three dimensional part produced using the thermally stable water soluble polymer composition and the build material. A variety of additives, such as those already disclosed above, can be added to a thermally stable water soluble polymer composition to form an article.

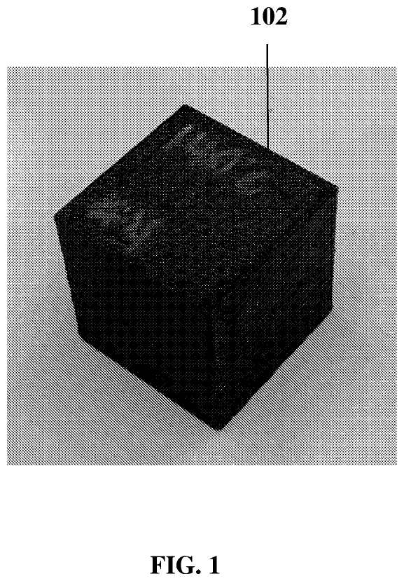

In one embodiment, a method of producing a thermally stable water soluble support includes melt processing at least one water soluble polymer and at least one reinforcing filler, converting the thermally stable water soluble polymer composition into a 3D printing feedstock, and 3D printing the thermally stable water soluble polymer composition to form a water soluble support or build material as shown as 102 in FIG. 1.

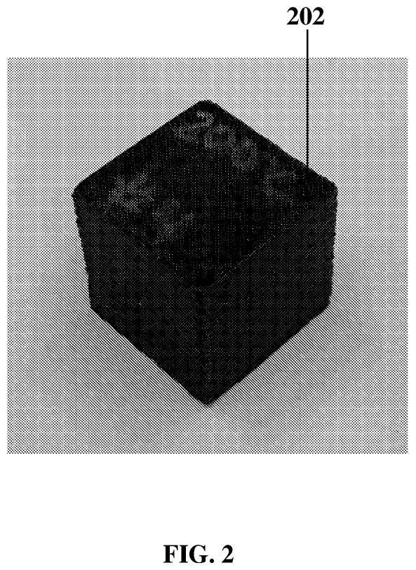

A thermally stable water soluble polymer composition can provide a number of advantages. For example, a thermally stable water soluble polymer composition can be substantially stable at build chamber temperatures of at least about 180 °C, or at least about 200 °C as shown as 202 in FIG. 2, or at least about 220 °C, or at least about 240 °C, or at least about 260 °C, or at least about 280 °C, and up to about 300 °C. When a thermally stable water soluble polymer composition is used to form a water soluble support, the water soluble support is also substantially stable at build chamber temperatures of 180 °C, or at least about 200 °C, or at least about 220 °C, or at least about 240 °C, or at least about 260 °C, or at least about 280 °C, and up to about 300 °C, as well as substantially dry at build chamber temperatures of at least about 180 °C.

Thermally stable water soluble polymer compositions and articles including such compositions have broad utility in a number of industries, including, but not limited to, additive manufacturing. These compositions and articles can provide significant value to plastics compounders and converters. The disclosed compositions and articles offer enhanced solubility and adhesion to a wide range of thermoplastic polymers, tunable rheological properties, and increased modulus at higher temperatures. Non-limiting examples of articles produced from such compositions include, but are not limited to; cushioning, textiles, medical supplies, automotive parts, filters, separators, armor, insulation, agricultural films, construction materials, aerospace parts, and soluble supports.

In the following examples, all parts and percentages are by weight unless otherwise indicated.

### Examples

TABLE 1
MATERIALS

| Material | Supplier |
|---|---|
| Water Soluble | “AQ55”, water soluble polymer, commercially |
| Polymer 1 (WSP 1) | available from Eastman Inc (Kingsport, TN) |
| Reinforcing | “NC7000”, multiwall carbon nanotubes, |
| Filler (RF 1) | commercially available from Nanocyl, Inc. |
| | (Sambrville, Belgium) |
| Stabilizer 1 (S1) | “Hostanox P-EPQ”, commercially available from |
| | Clariant (Germany) |
| Stabilizer 2 (S2) | “ADK STAB PEP-36”, commercially available from |
| | ADK (Japan) |
| Stabilizer 3 (S3) | Irgonox B215, commercially available from BASF |
| | (Germany) |
| Stabilizer 4 (S4) | Irgafos 168, commercially available from BASF |
| | (Germany) |

TABLE 2
EXPERIMENTAL FORMULATIONS

| Formulation | WSP 1 | RF1 | S1 | S2 | S3 | S4 |
|---|---|---|---|---|---|---|
| 1 | 96 | 4 | | | | |
| 2 | 95 | 5 | | | | |
| 3 | 94 | 6 | | | | |
| 4 | 93 | 7 | | | | |
| 5 | 92 | 8 | | | | |
| 6 | 92.5 | 7 | 0.5 | | | |
| 7 | 90.73 | 6.83 | 2.44 | | | |
| 8 | 88.57 | 6.67 | 4.76 | | | |
| 9 | 92.5 | 7 | | 0.5 | | |
| 10 | 90.73 | 6.83 | | 2.44 | | |
| 11 | 88.57 | 6.67 | | 4.76 | | |
| 12 | 92.5 | 7 | | | 0.5 | |
| 13 | 90.73 | 6.83 | | | 2.44 | |
| 14 | 88.57 | 6.67 | | | 4.76 | |
| 15 | 92.5 | 7 | | | | 0.5 |
| 16 | 90.73 | 6.83 | | | | 2.44 |
| 17 | 88.57 | 6.67 | | | | 4.76 |
| 18 | 100 | | | | | |
| 19 | 95 | | 5 | | | |
| 20 | 95 | | | 5 | | |
| 21 | 95 | | | | 5 | |
| 22 | 95 | | | | | 5 |

### Sample Preparation: Formulations 1-22

Each of Formulations 1-22 was prepared according to the weight ratios in Table 2. Formulations 1-22 were gravimetrically fed, using separate feeders, into a 27 mm twin screw extruder (52:1 L:D, commercially available from Entek, Lebanon, Oregon, United States). Compounding for formulations 1-18 were performed using the following temperature profile in zone 1 at 50 to 95 °F; zone 2 at 100 to 135 °F; zone 3 at 200 to 215 °F; zone 4 at 330 to 400 °F; zones 5 thru 13 at 400 to 450 °F; respectively and a die temperature of 430 °F. The extruder's screw speed was about 300 rpm, and the output rate was about 30 lbs/hr. Die pressures were recorded at 250 to 500 psi, with extruder torque readings ranging from 68 to 74%. The composite mixture was extruded onto an air cooled belt conveyor, pelletized using a Bullet model 62 pelletizer available from Maag Group, Oberglatt, Switzerland, into approximately 2.5 mm×2.5 mm cylindrical pellets, and collected in an aluminized bag.

### Filament Preparation: Formulation 4

Sample 4 pellets were converted to filament for use in FDM 3D printing at two standard diameters, 1.75 mm and 2.85 mm, using a 1.75″ single screw extruder commercially available from Davis-Standard, located in Pawcatuck, Connecticut, USA, equipped with a breaker plate, screen pack (40/60/80 mesh), and 2:1 barrier Maddock screw. To make the 1.75 mm filament, a temperature profile of 230 °C in zone 1, 232 °C in zone 2, 238 °C in zone 3, 236 °C in zone 4, and a die temperature of 234 °C was utilized along with a screw speed of about 10.7 rpm and an output rate of about 36 meters per minute. To make the 2.85 mm filament, a temperature profile of 230 °C in zone 1, 232 °C in zone 2, 238 °C in zone 3, 236 °C in zone 4, and a die temperature of 234 °C were utilized along with a screw speed of about 19.6 rpm and an output rate of about 20 meters per minute. Filament was extruded through a round die, air cooled, and wound onto a spool with a 3″ core.

### Dissolution Method Test 1: Formulations 1-22

For each of formulations 1-22, solubility was evaluated on a DISTEK 2500 dissolution tester (available commercially from Distek, Inc., North Brunswick, NJ), using the following procedure. A 5 gram sample in pellet form was placed in about 400 mL of tap water at about 80 °C, with a constant stir rate of 350 rpm. The dissolution time was reported at the time when the sample was completely solubilized, such that there were no observable pellets at the bottom of the dissolution vessel. The results are provided in Table 3.

TABLE 3
DISSOLUTION METHOD TEST 1 RESULTS

| | Disintegration | |
|---|---|---|
| Formulation | Time (min) | Observations |
| 1 | <5 min | Pellets disintegrated. Black colored |
| | | polymer solution with some black powder |
| 2 | <5 min | Pellets disintegrated. Black colored |
| | | polymer solution with some black powder |
| 3 | <5 min | Pellets disintegrated. Black colored |
| | | polymer solution with some black powder |
| 4 | <5 min | Pellets disintegrated. Black colored |
| | | polymer solution with some black powder |
| 5 | <5 min | Pellets disintegrated. Black colored |
| | | polymer solution with some black powder |
| 6 | <3 min | Pellets disintegrated. Black colored |
| | | polymer solution with some black powder |
| 7 | <3 min | Pellets disintegrated. Black colored |
| | | polymer solution with some black powder |
| 8 | <3 min | Pellets disintegrated. Black colored |
| | | polymer solution with some black powder |
| 9 | <3 min | Pellets disintegrated. Black colored |
| | | polymer solution with some black powder |
| 10 | <3 min | Pellets disintegrated. Black colored |
| | | polymer solution with some black powder |
| 11 | <3 min | Pellets disintegrated. Black colored |
| | | polymer solution with some black powder |
| 12 | <3 min | Pellets disintegrated. Black colored |
| | | polymer solution with some black powder |
| 13 | <3 min | Pellets disintegrated. Black colored |
| | | polymer solution with some black powder |
| 14 | <3 min | Pellets disintegrated. Black colored |
| | | polymer solution with some black powder |
| 15 | <3 min | Pellets disintegrated. Black colored |
| | | polymer solution with some black powder |
| 16 | <3 min | Pellets disintegrated. Black colored |
| | | polymer solution with some black powder |
| 17 | <3 min | Pellets disintegrated. Black colored |
| | | polymer solution with some black powder |
| 18 | 3 | Clear solution, fully dissolved |
| 19 | <3 min | Semi-hazy solution. Completely dissolved |
| 20 | <3 min | Hazy solution. Completely dissolved. |
| 21 | <3 min | Hazy solution. Completely dissolved. |
| 22 | <3 min | Hazy solution. Completely dissolved. |

### Annealing Method Test 1: Formulations 1-22

For each of formulations 1-22, an approximately 2 gram sample in pellet form was placed on a watch glass in a convection oven at 210 °C, with air atmosphere, for a period of 24 hrs., a parallel sample of the same formulation was run for 48 hrs. Samples were removed from the oven, allowed to cool to room temperature and solubility was evaluated using Dissolution Method Test 2 (below). The results are provided in Table 4.

TABLE 4
DISSOLUTION METHOD TEST 2 RESULTS
(FORMULATIONS 1-22 ANNEALED)

| | Disintegration Time | | | | Observations | |
|---|---|---|---|---|---|---|
| Formu- | 24 Hour | | 48 Hour | | 24 Hour | 48 Hour |
| lation | Anneal | | Anneal | | Anneal | Anneal |
| 1 | >1 | hr | NA | | partially | NA |
| | | | | | dissolved | |
| 2 | >1 | hr | NA | | partially | NA |
| | | | | | dissolved | |
| 3 | >1 | hr | NA | | partially | NA |
| | | | | | dissolved | |
| 4 | >1 | hr | NA | | poor dissolution | NA |
| 5 | >1 | hr | NA | | poor dissolution | NA |
| 6 | >1 | hr | >1 | hr | fragments, poor | fragments, poor |
| | | | | | dissolution | dissolution |
| 7 | >1 | hr | >1 | hr | fragments, poor | fragments, poor |
| | | | | | dissolution | dissolution |
| 8 | >1 | hr | >1 | hr | fragments, poor | fragments, poor |
| | | | | | dissolution | dissolution |
| 9 | >1 | hr | >1 | hr | fragments, poor | fragments, poor |
| | | | | | dissolution | dissolution |
| 10 | >1 | hr | >1 | hr | fragments, poor | fragments, poor |
| | | | | | dissolution | dissolution |
| 11 | >1 | hr | >1 | hr | fragments, poor | fragments, poor |
| | | | | | dissolution | dissolution |
| 12 | >1 | hr | >1 | hr | poor/no | fragments, poor |
| | | | | | dissolution | dissolution |
| 13 | >1 | hr | >1 | hr | poor/no | poor/no |
| | | | | | dissolution | dissolution |
| 14 | >1 | hr | >1 | hr | poor/no | poor/no |
| | | | | | dissolution | dissolution |
| 15 | >1 | hr | >1 | hr | poor/no | poor/no |
| | | | | | dissolution | dissolution |
| 16 | >1 | hr | >1 | hr | poor/no | poor/no |
| | | | | | dissolution | dissolution |
| 17 | >1 | hr | >1 | hr | poor/no | poor/no |
| | | | | | dissolution | dissolution |
| 18 | 23 | min | NA | | dissolved | NA |
| 19 | <20 | min | <20 | min | dissolved | dissolved |
| 20 | <20 | min | <20 | min | dissolved | dissolved |
| 21 | <20 | min | <20 | min | dissolved | dissolved |
| 22 | <20 | min | <20 | min | dissolved | dissolved |

### Dissolution Method Test 2: Formulations 1-22 (Annealed Samples)

For each of formulations 1-22 which were annealed using Annealing Method Test 1 (above), were removed from the oven and cooled to room temperature. Since samples were adhered to the watch glass, the entire watch was subjected to the dissolution procedure. Watch glass and sample were placed in about 400 mL of tap water at about 80 °C, with a constant stir rate of 100 rpm. The dissolution time was reported at the time when the sample was completely disintegrated, such that there was no observable mass on the watch glass at the bottom of the dissolution vessel. The results are provided in Table 4.

### Annealing Method Test 2: Formulations 18-22

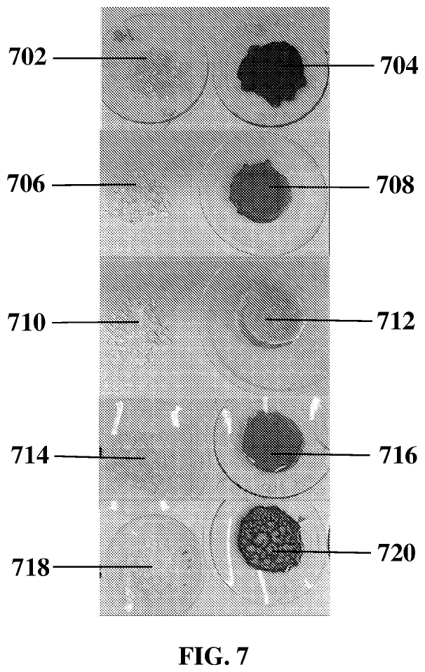

For each of formulations 18-22, an approximately 2 gram sample in pellet form was placed on a watch glass in a convection oven at 210 °C, with air atmosphere. Samples were monitored and imaged initially (time=0) and after 24 hours of exposure. The results are provided in Table 5. FIG. 7 shows images of each formulation and its resulting appearance. 702 is formulation 18 in pellet form. 704 is the resulting appearance of formulation 18. 706 is formulation 19 in pellet form. 708 is the resulting appearance of formulation 19. 710 is formulation 20 in pellet form. 712 is the resulting appearance of formulation 20. 714 is formulation 21 in pellet form. 716 is the resulting appearance of formulation 21. 718 is formulation 22 in pellet form. 720 is the resulting appearance of formulation 21.

TABLE 5
ANNEALING METHOD TEST 2 OBSERVATIONS
(FORMULATIONS 18-22)

| Formulation | Initial Appearance | 24 hr-210 °C Appearance |
|---|---|---|
| 18 | Clear light amber pellets | Dark brown melt |
| 19 | Clear light amber pellets | Clear brown-amber melt |
| 20 | Clear light amber pellets | Clear light amber melt |
| 21 | Opaque light amber pellets | Hazy sienna melt |
| 22 | Opaque white pellets | Black melt |

### Capillary Rheology Characterization

Capillary rheology analysis was performed on Formulations 1-5, and 18 using a capillary rheometer (Commercially available from Dynisco, Franklin, Massachusetts). All Formulations were analyzed at 250 °C, using a cone die. Formulations were analyzed at variable shear rates from 100 and 30,0000 s⁻¹. Table 6 shows the results of this characterization, specifically apparent viscosity under low shear (200 s⁻¹) and high shear (10,500 s⁻¹) conditions.

TABLE 6
APPARENT VISCOSITY RESULTS
FORMULATIONS 1-5, and 18

| | Apparent Viscosity (Pa-s) | Apparent Viscosity (Pa-s) |
|---|---|---|
| Formulation | at 250 °C and 200 s⁻¹ | at 250 °C and 10,500 s⁻¹ |
| 18 | 370 | 90 |
| 1 | 680 | 115 |
| 2 | 780 | 120 |
| 3 | 800 | 120 |
| 4 | 740 | 100 |
| 5 | 850 | 120 |

### Torsional Dynamic Mechanical Analysis Characterization

Torsional Dynamic Mechanical Analysis (DMA) was performed on injection molded test parts of formulations 1-5, 8, and 18 using a Anton-Paar MCR702 (Commercially available from Anton-Paar, Graz, Austria). The molded samples were analyzed by DMA over a temperature range of 20 °C-300 °C. Table 7 shows the results of this characterization, specifically storage modulus at specific temperatures.

TABLE 7
DYNAMIC MECHANICAL ANALYSIS TORSIONAL
STORAGE MODULUS AT TEMPERATURE RESULTS
Formulations 1-5, 8, 18

| | 150 °C | 200 °C | 250 °C | 300 °C |
|---|---|---|---|---|
| | Modulus | Modulus | Modulus | Modulus |
| Formulation | (Pa) | (Pa) | (Pa) | (Pa) |
| 18 | <1.0E05 | <1.0E05 | <1.0E05 | <1.0E05 |
| 1 | 1.84E06 | <1.0E05 | <1.0E05 | <1.0E05 |
| 2 | 2.89E06 | 9.63E05 | 8.06E05 | 9.56E06 |
| 3 | 3.47E06 | 1.39E06 | 1.21E06 | 1.43E06 |
| 4 | 4.35E06 | 2.07E06 | 1.93E06 | 2.25E06 |
| 5 | 3.97E06 | 1.87E06 | 1.77E06 | 2.12E06 |
| 8 | 4.53E06 | 2.10E06 | 1.92E06 | 2.16E06 |

To show that the modulus was not an artifact of molding, samples of formulation 4 were printed on the Arburg Freeformer 300X, and characterized by DMA using the methods previously described. Table 8 shows the results of this characterization, specifically storage modulus at specific temperatures.

TABLE 8
DYNAMIC MECHANICAL ANALYSIS TORSIONAL STORAGE
MODULUS AT TEMPERATURE RESULTS Formulation
4, molded versus printed parts.

| | | 150 °C | 200 °C | 250 °C | 300 °C |
|---|---|---|---|---|---|
| Formula- | | Modulus | Modulus | Modulus | Modulus |
| tion | Article | (Pa) | (Pa) | (Pa) | (Pa) |
| 4 | molded part | 4.35E06 | 2.07E06 | 1.93E06 | 2.25E06 |
| 4 | printed part | 1.52E06 | 1.05E06 | 1.46E06 | 1.80E06 |

Having thus described particular embodiments, those of skill in the art will readily appreciate that the teachings found herein may be applied to yet other embodiments within the scope of the claims hereto attached.

What is claimed is:

1. A thermally stable water soluble polymer composition comprising:
at least one water soluble polymer; and
at least one reinforcing filler;
wherein the composition is stable at printing temperatures up to 300 °C and build chamber temperatures greater than 180 °C and remains soluble after 24 hours of exposure at 180 °C.

2. The thermally stable water soluble polymer composition of claim 1, wherein the water soluble polymer is a sulfopolyester salt.

3. The thermally stable water soluble polymer composition of claim 1, wherein the reinforcing filler is carbon nanotubes.

4. The thermally stable water soluble polymer composition of claim 1, further comprising one or more additives.

5. The thermally stable water soluble polymer composition of claim 4, wherein the additive is an stabilizer.

6. The thermally stable water soluble polymer composition of claim 5, wherein the stabilizer is a phosphite based stabilizer.

7. The thermally stable water soluble polymer composition of claim 1, wherein the thermally stable water soluble polymer composition is substantially stable at a build chamber temperature of at least about 180 °C.

8. The thermally stable water soluble polymer composition of claim 1, wherein the thermally stable water soluble polymer composition is substantially stable at a build chamber temperature of at least about 200 °C.

9. The thermally stable water soluble polymer composition of claim 1, wherein the thermally stable water soluble polymer composition is substantially stable at a build chamber temperature of at least about 220 °C.

10. The thermally stable water soluble polymer composition of claim 1, wherein the thermally stable water soluble polymer composition is substantially stable at a build chamber temperature of at least about 240 °C.

11. The thermally stable water soluble polymer composition of claim 1, wherein the thermally stable water soluble polymer composition is substantially stable at a build chamber temperature of at least about 260 °C.

12. The thermally stable water soluble polymer composition of claim 1, wherein the thermally stable water soluble polymer composition is substantially stable at a build chamber temperature of at least about 300 °C.

13. The thermally stable water soluble polymer composition of claim 1, wherein the thermally stable water soluble polymer composition forms a feedstock.

14. An article comprising the thermally stable water soluble polymer composition of claim 1.

15. A method comprising:
melt processing at least one water soluble polymer and at least one reinforcing filler to form a thermally stable water soluble polymer composition;
forming a feedstock from the thermally stable water soluble polymer composition; and
3D printing the feedstock to form a water soluble support.

16. The method of claim 15, wherein the step of 3D printing forms an article.

17. A water soluble support comprising:
a thermally stable water soluble polymer composition, formed by melt processing at least one water soluble polymer and at least one reinforcing filler;
wherein the water soluble support is substantially dry and substantially stable at a build chamber temperature of at least about 180 °C.

18. The water soluble support of claim 17, wherein the water soluble support is substantially stable at a build chamber temperature of at least about 220 °C.

19. The water soluble support of claim 17, wherein the water soluble support is substantially stable at a build chamber temperature of at least about 260 °C.

20. A three-dimensional printed article comprising:
a three-dimensional printed object generally deposited on a substantially horizontal build plate in a build chamber; and
one or more water soluble supports positioned about and supporting one or more portions of the three-dimensional printed object, the water soluble supports comprise a thermally stable water soluble polymer composition;
wherein the thermally stable water soluble polymer composition is formed by melt processing at least one water soluble polymer and at least one reinforcing filler.

21. The three-dimensional printed article of claim 20, wherein the thermally stable water soluble polymer composition is substantially stable at a build chamber temperature of at least about 180 °C.

22. The three-dimensional printed article of claim 20, wherein the thermally stable water soluble polymer composition is substantially stable at a build chamber temperature of at least about 220 °C.

23. The three-dimensional printed article of claim 20, wherein the thermally stable water soluble polymer composition is substantially stable at a build chamber temperature of at least about 260 °C.

24. The three-dimensional printed article of claim 20, wherein the thermally stable water soluble polymer composition is substantially stable at a build chamber temperature of at least about 300 °C.
